(19) United States
(12) Patent Application Publication
(10) Pub. No.: US 2013/0166465 A1
(43) Pub. Date: Jun. 27, 2013

(54) SYSTEMS AND METHODS FOR SOCIAL TAGGING AND LOCATION-BASED RESUME-RELATED AND NETWORKING APPLICATIONS

(71) Applicants: PABLO F. BARROS, Jacksonville, FL (US); David J. Dandeneau, Issaquah, WA (US); Anthony J. Edwards, Snoqualmie, WA (US); Doug S. Smith, Saint Augustine, FL (US)

(72) Inventors: PABLO F. BARROS, Jacksonville, FL (US); David J. Dandeneau, Issaquah, WA (US); Anthony J. Edwards, Snoqualmie, WA (US); Doug S. Smith, Saint Augustine, FL (US)

(73) Assignee: Oracle International Corporation, Redwood Shores, CA (US)

(21) Appl. No.: 13/604,679

(22) Filed: Sep. 6, 2012

Related U.S. Application Data
(60) Provisional application No. 61/532,313, filed on Sep. 8, 2011.
(60) Provisional application No. 61/532,646, filed on Sep. 9, 2011.

(51) Int. Cl. G06Q 10/10

(52) U.S. Cl. CPC G06Q 10/1053
USPC 705/319

(57) ABSTRACT

Embodiments of the invention provide systems and methods for managing a talent network. According to one embodiment, an application may be used by both job applicants and human resources and recruiting managers to create tag endorsements, conduct on-the-go networking, and to apply for jobs directly from the mobile device. The application may be run on either a mobile device or a desktop or a networked computer. While the disclosed application may be run on a desktop computer, mobile devices may allow a user to fully utilize all of the features of the application. Mobile devices may include smart phones, tablet computers, or laptop computers. Each user's mobile devices may connect to one or more centralized servers for the application that store the user's personal profile, tags, and location.

### CROSS-REFERENCES TO RELATED APPLICATIONS

The present application claims benefit under 35 USC 119(e) of U.S. Provisional Application No. 61/532,313, filed on Sep. 8, 2011 by Barros et al. and entitled “System and Methods for Social Tagging and Location-Based Resume-Related and Networking Applications,” of which the entire disclosure is incorporated herein by reference for all purposes.

### TECHNICAL FIELD

The present disclosure relates to a mobile device application that may be used by both job applicants and human resource and recruiting managers to create tag endorsements, network while on-the-go, and apply for jobs directly from a mobile device. The mobile device application may also be used to enable talent networking by professionals by matching skills and experiences with potential opportunities. Mobile devices may include smart phones, tablet computers, or laptop computers, each of which may connect to one or more centralized servers that store each user's personal profile, tags, and location.

### BACKGROUND

Recruiters and hiring managers are typically some of the busiest people in an organization and are constantly on-the-move, both within the office, setting up and conducting interviews, and outside of the office, attending career fairs, on campus interviews, and the like. There are often location and time elements associated with hiring based on the organization's needs, the candidate's job search, and the candidate's current job situation. Oftentimes, a candidate will be located in a different city or state and may not be able to attend an interview in-person or relocate in time to meet the organization's needs during the hiring process.

In addition to the needs faced by recruiters and hiring managers on a daily basis, successful professionals want to be able to network while on-the-go by matching their talents with unique opportunities that may present themselves. Opportunities can be presented in many ways, including a key meeting or a specific introduction, but they can also present themselves in chance encounters while out-and-about. For example, a software development manager may be looking for a new developer that is proficient in a certain software language. If that developer is standing next to the software manager in line at a coffee shop or at a sporting event, that networking opportunity could be lost if the software manager and the developer do not know about each other and the potential opportunity.

Therefore, it is desired that recruiters and hiring managers be able to network while out-and-about with specific candidates and vice versa based on a specific job opening and/or geographic proximity to each other and that professionals be able to network based on their unique skills and experiences and potential opportunities.

### SUMMARY

The present disclosure relates to an application that may be used by job applicants, human resource and recruiting managers, and professionals on either a mobile device such as a smart phone or tablet computer or on a laptop or desktop computer. The application may allow a user to tag themselves with a single tag and to receive tags from their connections. Each tag may be a single descriptive word associated with the tagged user. Tags may be considered endorsements, helping to build a user's reputation in their network, and may be searchable on the mobile device application, as well as on a laptop or desktop computer. Additionally, tags may be unique in that each user may only tag one of their connections with one tag, preventing economics of scale from causing users to want to get multiple tags from a single person. The tags may also be scored based on a scoring algorithm so that for each tag, a tag leaderboard may be easily created, letting both job applicants and recruiting managers know the rankings of users for that tag.

In addition, the application may allow for location-based networking where users may “check-in” based on their geographic location using either a smart phone, tablet computer, or laptop computer. Users may create a personal profile with their name, contact information, job description, and a brief descriptive blurb. After checking-in, a user's location may be pinpointed based on latitude and longitude and then displayed on a graphical user interface. The user may also see which of their other connections have checked-in and are located in close proximity on the graphical user interface. The user may use the application to enable talent networking by matching skills and experiences with potential opportunities in close proximity. The user may then determine whether they would like to connect with a fellow user and network while on-the-go. During or after networking, the user may also wish to apply for a job while still away from their home or office. The application may allow users to apply for a job directly from their mobile device or laptop computer using information already stored in their personal profile, and then the user may only have to fill in any additional information that the specific organization requires. This allows both job applicants and recruiters to capitalize on networking meetings.

Stated another way, managing a talent network can comprise registering each of a plurality of users of the talent network. Registering each user can include generating a profile for each user and defining professional information in the profile for each user. The professional information can be defined based on at least one of information imported from one or more social network profiles of the user or information provided by the user. A selected social network can be searched for connections associated with each of the plurality of registered users in the selected social network. A tag can be applied to each connection identified by said searching. Each tag can comprise a unique endorsement of the connection by the registered user associated with that connection.

In some cases, the talent network can be used to identify job candidates for an open position. Using the talent network to identify job candidates for the open position can comprise searching the tags applied to each connection for information matching a criteria related to the open position to identify the job candidates from the connections, counting a number of connections at each of a plurality of levels for each of the job candidates based on the tags applied to connection, and scoring each job candidate based on the number of connections at each of the plurality of levels. The job candidates can be filtered based on a location of the job candidate and a location criteria of the open position. Additionally or alternatively, the job candidates can be filtered based on an education and employment history of the candidate and education and employment criteria of the open position. The job candidates can then be ranked based on the score for each of the job candidates and said filtering.

In some cases, registering the plurality of users can comprise registering one or more of the plurality of users for a location-based service of the talent network. A first registered user of the location-based service can be provided with a list of other registered users based on proximity. A selection of one of the other registered users of the list of other registered users can be received from the first user. Upon this selection, the user profile of the selected other registered user can be provided to the first user. In response to an instruction from the first registered user, a connection from the first user to the selected other registered user can be added in the talent network.

Additionally or alternatively, information about a set of open positions or user profile information for users in search of open positions can be provided to a registered user of the location-based service based on location information of the location-based service. Input can be received from the registered user for the information about the set of open positions or user profile information for users in search of open positions. The information about the set of open positions or user profile information for users in search of open positions can be updated based on the input from the registered user.

In some cases, the one or more open positions can be searched based on the user profile for one of the registered users. An indication of one or more open positions can be provided to the user based on said searching. A selection of one of the open positions can be received from the user and, in response, application information related to the selected open position can be updated using information from the user profile of the user.

### BRIEF DESCRIPTION OF THE DRAWINGS

FIG. 1 is a system level diagram of the architecture of the mobile device application of an embodiment of the present disclosure;

FIG. 2 is a process flow chart for registering for and logging on to a social tagging application and applying a tag (from a user's perspective), in accordance with one embodiment of the disclosure;

FIG. 3 is a screen shot of a particular step of the process of FIG. 2, in accordance with one embodiment of the present disclosure;

FIG. 4 is a screen shot of a particular step of the process of FIG. 2, in accordance with one embodiment of the present disclosure;

FIG. 5 is a screen shot of a particular step of the process of FIG. 2, in accordance with one embodiment of the present disclosure;

FIG. 6 is a process flow chart for applying tags to a user's connections, in accordance with one embodiment of the present disclosure;

FIG. 7 is a screen shot of the steps in the process flow chart of FIG. 6, in accordance with one embodiment of the present disclosure;

FIG. 8 is a screen shot of the steps in the process flow chart of FIG. 6, in accordance with one embodiment of the present disclosure;

FIG. 9 is a screen shot depicting a status update on a user's Facebook page, in accordance with one embodiment of the present disclosure;

FIG. 10 is a process flow chart for scoring search results based on tags, in accordance with one embodiment of the present disclosure;

FIG. 11 is a process flow chart for HR/recruiting managers to find a job applicant for a specific job opening, in accordance with one embodiment of the present disclosure;

FIG. 12 is a process flow chart for using a location-based application, in accordance with one embodiment of the present disclosure;

FIG. 13 is process flow chart for a user to edit their profile in the location-based application of FIG. 12, in accordance with one embodiment of the present disclosure;

FIG. 14 is a screen shot depicting a user's profile in the location-based application of FIG. 13, in accordance with one embodiment of the present disclosure;

FIG. 15 is a screen shot depicting a user editing their profile in the location-based application of FIG. 13, in accordance with one embodiment of the present disclosure;

FIG. 16 is a process flow chart for a user to view other location-based application connections in close proximity to the user of FIG. 12, in accordance with one embodiment of the present disclosure;

FIG. 17 is a screen shot depicting a list of a user s connections checked-in to the location-based application of FIG. 16 and their relative proximities to the user, in accordance with one embodiment of the present disclosure;

FIG. 18 is a screen shot depicting a detailed profile of a connection in close proximity to the user, and an option to contact the connection of the location-based application of FIG. 17, in accordance with one embodiment of the present disclosure;

FIG. 19 is a screen shot depicting a detailed profile of a connection in close proximity to the user, and an option to connect with the connection of the location-based application of FIG. 17, in accordance with one embodiment of the present disclosure;

FIG. 20 is a process flow chart for a user to view his or her pending and confirmed connections of the location-based application of FIG. 12, in accordance with one embodiment of the present disclosure;

FIG. 21 is a screen shot depicting a user's pending and confirmed connections of the location-based application of FIG. 21, in accordance with one embodiment of the present disclosure;

FIG. 22 is a process flow chart for a user to view and/or post job listings in the location-based application of FIG. 12, in accordance with one embodiment of the present disclosure;

FIG. 23 is a screen shot depicting a series of job posts in the location-based application of FIG. 22, in accordance with one embodiment of the present disclosure;

FIG. 24 is a screen shot depicting a detailed job post in the location-based application of FIG. 23, in accordance with one embodiment of the present disclosure; and

FIG. 25 is a process flow chart for a user to search for and apply for jobs on a mobile device, in accordance with one embodiment of the present disclosure.

FIG. 26 is a block diagram illustrating components of an exemplary operating environment in which various embodiments of the present invention may be implemented.

FIG. 27 is a block diagram illustrating an exemplary computer system in which embodiments of the present invention may be implemented.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a machine readable medium. A processor(s) may perform the necessary tasks.

The present disclosure relates generally to an application that may be used by both job applicants and human resources and recruiting managers to create tag endorsements, conduct on-the-go networking, and to apply for jobs directly from the mobile device. The application may be run on either a mobile device or a desktop or a networked computer. White the disclosed application may be run on a desktop computer, mobile devices may allow a user to fully utilize all of the features of the application. Mobile devices may include smart phones, tablet computers, or laptop computers. Each user's mobile devices may connect to one or more centralized servers for the application that store the user's personal profile, tags, and location.

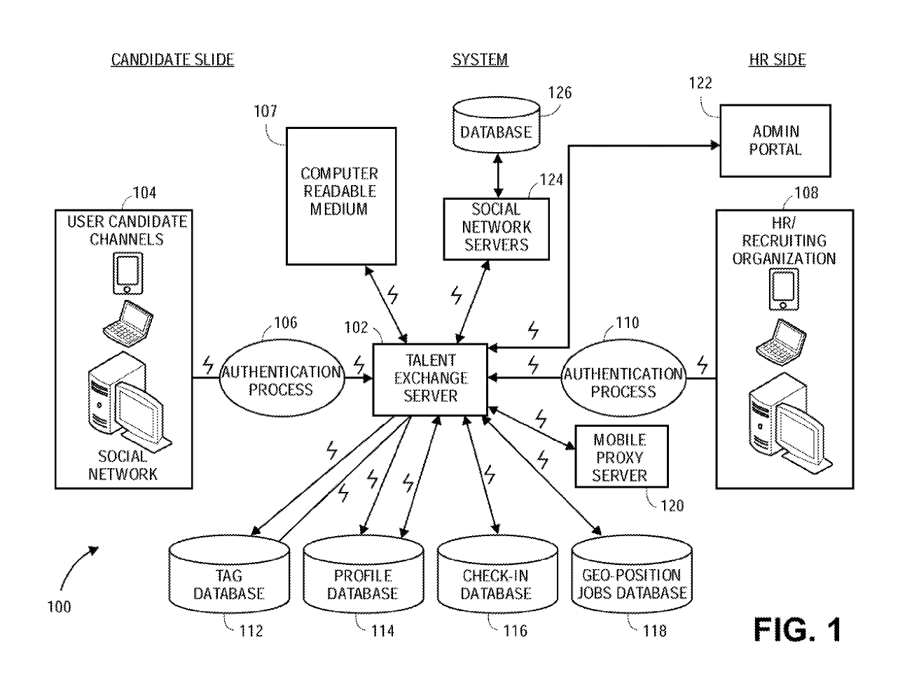

FIG. 1 is a system level diagram 100 of the architecture of an embodiment of the present disclosure. The architecture may be centered around a talent exchange server 102 that may include operating code comprising computer instructions stored on a computer-readable medium 107 and may comprise a candidate side and an employer side. On the candidate side, the talent exchange server 102 may be connected to one or more user candidate channels 104 via an internet connection and an authentication process 106. On the employer side, the talent exchange server 102 may be connected to one or more HR/recruiting channels 108 via an internet connection and an authentication process 110.

The one or more user candidate channels 104 may be accessible by a job applicant from a variety of channels, including a smart phone, such as an iPhone, a BlackBerry, or an Android phone, a laptop computer, a desktop computer, a networked computer, or directly through a social networking website or application. Social networking websites/applications may include Facebook, Google+, Twitter, Viadeo, and LinkedIn, e.g., but is not limited to those social networking websites/applications specifically.

The one or more HR/recruiting channels 108 may be accessible by a HR manager or a recruiting employee from a variety of channels, including a smart phone, such as an iPhone, a BlackBerry, or an Android phone, a laptop computer, a desktop computer, or a networked computer. The talent exchange server 102 may also be connected to an admin portal 122. The admin portal 122 may be located proximate to the HR/recruiting channels 108 or may be located off-site from the HR/recruiting channels 108 and may be used by an administrator to control functions of the mobile device application not available to all employees.

The talent exchange server 102 may also be connected with a variety of databases, including a tag database 112, a profile database 114, a check-in database 116, and a geo-position jobs database 118. These databases 112, 114, 116, 118 may be located proximate to the talent exchange server 102 and may be connected via networking cables, or may be located off-site from the talent exchange server 102 and may be connected via an internet connection. The talent exchange server 102 may also be connected to a mobile proxy server 120 that will be described in more detail in relation to both social tagging and location-based networking

The talent exchange server 102 may also be directly connected to one or more social networking servers 124 via an interact connection. The one or more social networking servers 124 may each comprise a database 126, allowing the talent exchange server 102 to connection into the social networking servers 124. The one or more social networking servers 124 may connect with social networking websites/applications such as Facebook, Google+, Twitter, Viadeo, and LinkedIn, e.g., but is not limited to those social networking websites/applications specifically.

The architecture depicted in the system level diagram 100 in FIG. 1 may be used as an architecture for both social tagging and location-based networking. The talent exchange server 102 may be used to implement a centralized global dashboard where all tagging, location-based networking functionalities, employer correspondence notifications, and employer job search are located on one application on the user's mobile device or computer, eliminating the need for multiple websites, log on user names and passwords, etc.

### Social Tagging Application

Utilizing the architecture described above in FIG. 1, job candidates may use a social tagging application to add professional tags to their own profile and to their connections' profiles. Social tagging is a process that utilizes social networking to add one or two word tags to a user's profile. The architecture of the social tagging application may be centered around the talent exchange server 102 operating code comprising computer instructions stored on the computer-readable medium 107.

Tags are unique because they are endorsements from a user's professional contacts. Users are only allowed to tag themselves with the one tag, may only receive one tag from each of their social networking connections, and may only tag each of their social networking connections with one tag. This helps to maintain that there is an economics to the number of tags and prevents users from self-tagging themselves with an endless number of tags, This allows each tag to be of equal weight, and a user can only get additional tags by having additional contacts tag them

These tags can then be used by HR/recruiting managers to see how a user has been characterized by his or her social network connections. Tags may also be searchable and may be scored to return job candidates most-tailored to fit the particular needs of an organization. For example, if a company is looking to hire a computer programmer specializing in developing mobile applications, a HR manager could search a pool of job applicants and their professional contacts across all social networks for tags such as “web,” “HTML,” or “Java.”

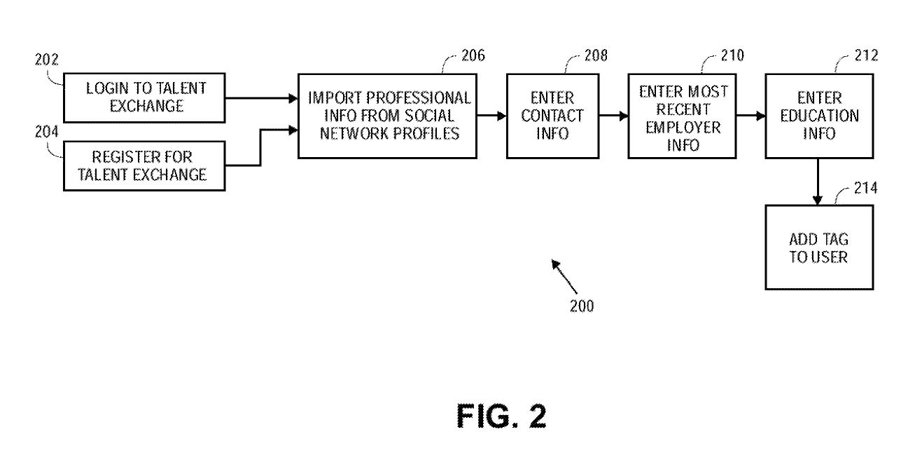

Referring now to FIG. 2, a process flow chart 200 for registering for and logging on to a social tagging application and applying a tag (from a user's perspective) is shown, in accordance with one embodiment of the disclosure. To start using talent exchange and social tagging application, at step 202, a user would login to the talent exchange application 102 via the authentication process 106 if the user has already registered for the talent exchange application. if the user has previously registered, the user may only have to enter his or her email address and password. If the user has not previously registered for the talent exchange application, the user may have to register for the talent exchange application at step 204. If the user has not previously registered, the user may have to enter his or her name, email address, create a password, confirm the password, and then enter a displayed verification code. The user may also have to enter his or her current job title and industry.

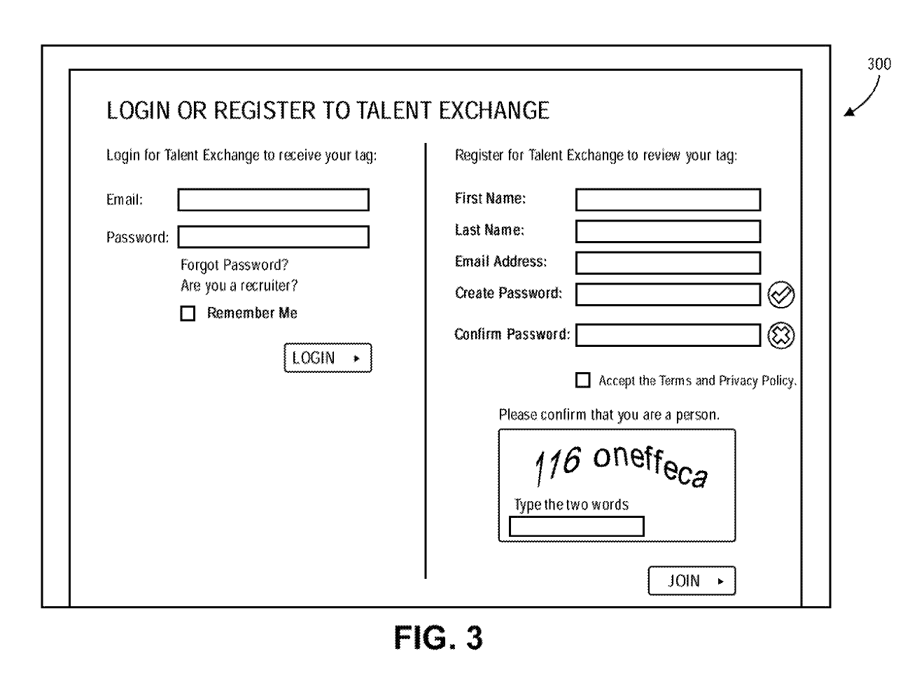

FIG. 3 is a screen shot 300 of a particular step of the process of FIG. 2, in accordance with one embodiment of the present disclosure. The screen shot 300 depicts that the user may have the option of logging-in or registering for the social tagging application. In FIG. 3, user Michael Romero is registering for a new account for the social tagging application.

Referring back to FIG. 2, once registered for or logged on to the talent exchange application, at step 206, the user may select to import their professional information from one or more of their social networking profiles. The user may be prompted to check a box for each of the social networks he or she wishes to import or the user may select to import his or her profile from all social networks. As discussed previously, the social networks may comprise Facebook, Google+, Twitter, Viadeo, and LinkedIn, e.g.

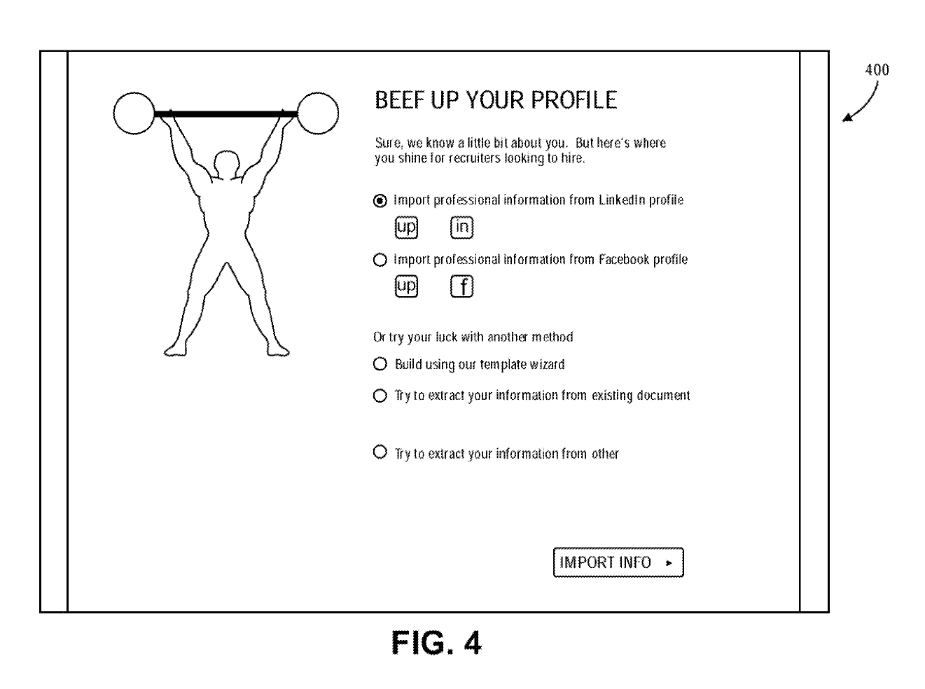

FIG. 4 is a screen shot 400 of a particular step of the process of FIG. 2, in accordance with one embodiment of the present disclosure. The screen shot 400 depicts that the user may import their professional information from one or more social networks. In FIG. 4, user Michael Romero has chosen to import his professional information from his LinkedIn profile.

Referring back to FIG. 2, once the user's professional information has been imported to the talent exchange application from his or her social networks, the user may be prompted to enter additional information. At step 208, the user may be prompted to enter his or her contact number and location, including country, state, city, and zip code. At step 210, the user may be prompted to enter his or her most recent employment information, including employer, title, start date, end date, and a description. This information will be stored in the profile database 114 for each user. At step 212, the user may be prompted to enter his or her educational information, including institution, degree, start date, end date, and whether the degree was received. In both steps 210, 212, the user may have the option of adding additional employment and/or educational information.

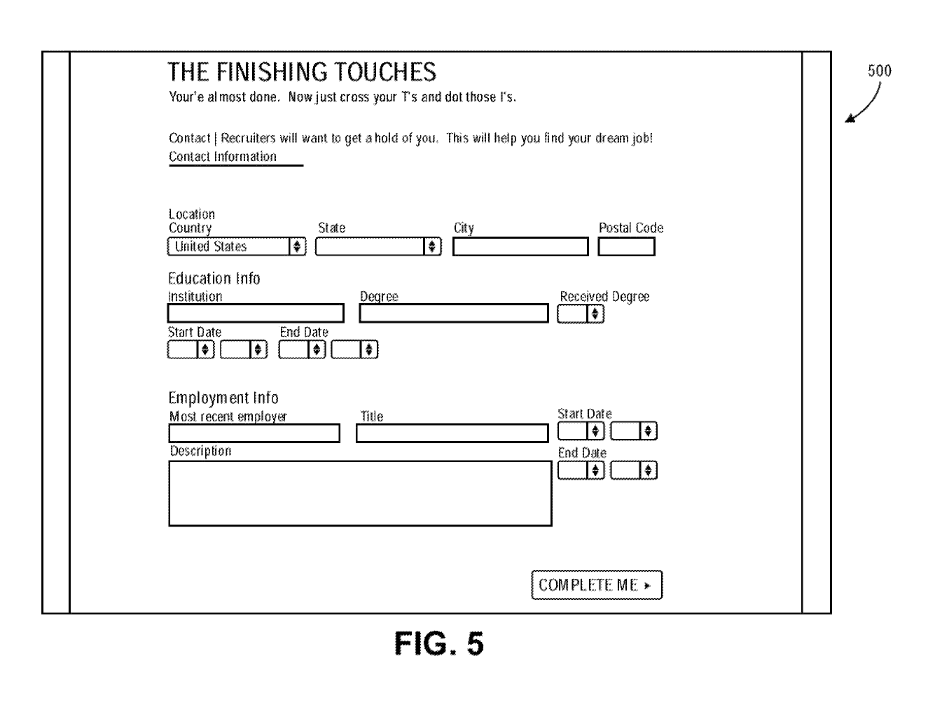

FIG. 5 is a screen shot 500 of a particular step of the process of FIG. 2, in accordance with one embodiment of the present disclosure. The screen shot 500 depicts the various fields that the user may be prompted to fill out before using the social tagging application for the first time.

Referring back to FIG. 2, after completing the registration process and logging on to the talent exchange application, at step 214, the user may then he prompted to tag him or herself. The initial tag may give recruiters a quick professional look at the user and may tell the user's friends how the user would like their friends to tag them. A tag may be any word that represents a quality, skill, profession, or anything else. As an example, if a user sells farm equipment, good tags may be “sales,” “agriculture,” “persistence,” or “committed,” for example. The user's tag may be stored in both the tag database 112 and the profile database 114, as shown in FIG. 1.

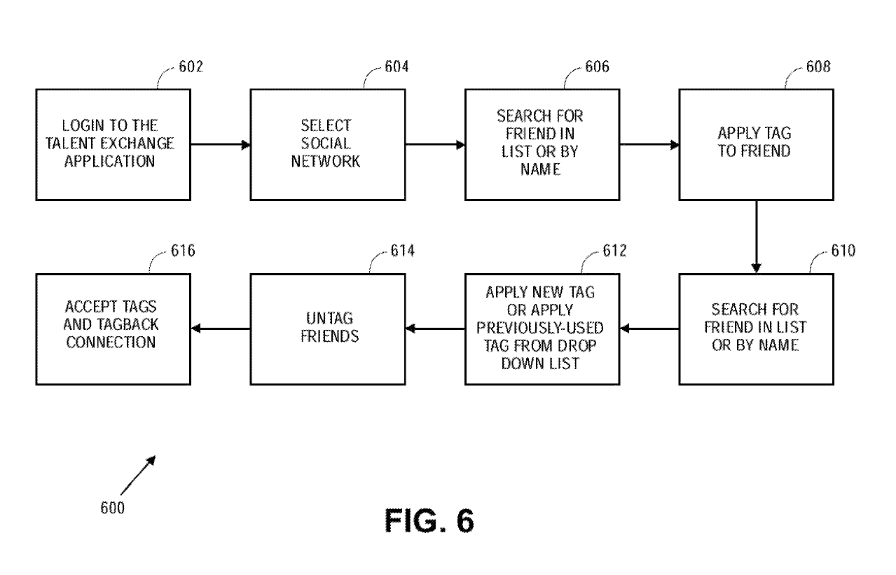

Referring now to FIG. 6, a process flow chart 600 for applying tags to a user's connections is shown, in accordance with one embodiment of the present disclosure. At step 602, the user may login to the talent exchange application, as previously described. After logging on, at step 604, the user may select the social network that he or she would like to tag friends from. As discussed previously, the social networks may comprise Facebook, Google+, Twitter, Viadeo, and LinkedIn, e.g. The social networks available to tag in may be listed as tabs across the top of a screen, as a list where the user may have to check a box for the desired social network, or as a drop-down menu.

After selecting the social network the user wants to tag his or her connections in, at step 606, the user may search for a friend either by first or last name in a search box or may find a connection in an alphabetical list at step 606. Once the user locates the connection they wish to tag, at step 608, he or she may apply a tag to the connection. If the user is applying the first tag to a connection, the user will have to type in the tag and then click “tag” or “apply.” The tag may be stored in both the tag database 112 and the profile database 114 for the connection, as shown in FIG. 1.

After applying a tag to a connection, at step 610 the user may have the option of searching for a separate connection to tag. The user search for a connection either by first or last name in a search box or may find a friend in an alphabetical list. Once the user locates the connection they wish to tag, at step 612, he or she may apply a tag to the friend. Because this is no longer the first tag applied, the user may select a previously used tag from a drop-down list or may type in a new tag. The user may then click “tag” or “apply.” The tag may be stored in both the tag database 112 and the profile database 114 for the connection, as shown in FIG. 1.

The user may continue this process for as many of their connections as they wish to tag. For example, if a real-estate agent would like to tag all of his professional real-estate friends with the tag “real-estate,” that user would search for each of his friends and continue to select the previously-used “real-estate” tag from the drop-down list.

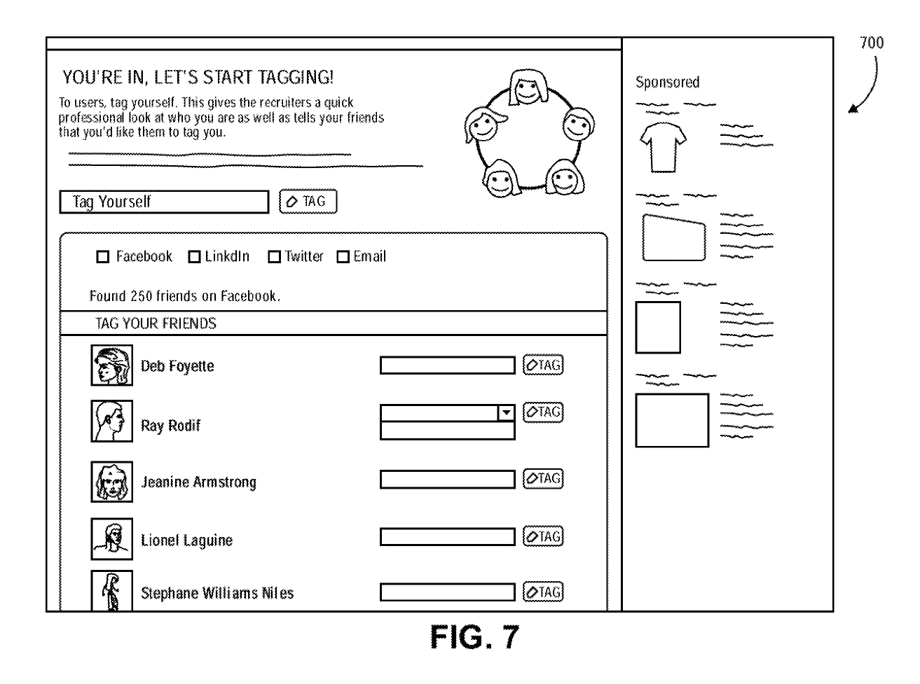

FIG. 7 is a screen shot 700 of steps 604, 606, 608, 610, 612 in the process flow chart of FIG. 6. The screen shot 700 depicts that the user has not tagged himself yet, but has tagged his Facebook friend Ray Rodil with the tag “developer.” As shown by the tabs, the user may tag connections from his Facebook, LinkedIn, and Twitter accounts, along with his email contacts. The user may apply tags to his friends that appear in the list (Debi, Jeanine, Lionel, and Stephanie) or may search for Facebook friends in the search box on the right-hand side of the screen. The user may also tag himself with any professional tag that he desires.

Referring back to FIG. 6, after applying professional tags to social networking connections, at step 614, the user may decide to remove a previously applied tag. Next to each friend who has been previously tagged may be their current tag and a “untag” or “remove tag” button. The user may click this button to remove the tag, and the tag may be removed from the tag database 112 and the profile database 114 for the connection.

The social networking application may also tell the user what tags have been applied to them by their connections and may give the user the option to accept the tag and/or tagback that connection at step 616.

It is important to note that after logging in to the social tagging application at step 602, the remaining steps may be taken in any order depending on the user's desires. For example, the user may tag friends, untag friends, accept tags, tagback friends, or tag him or herself after logging in.

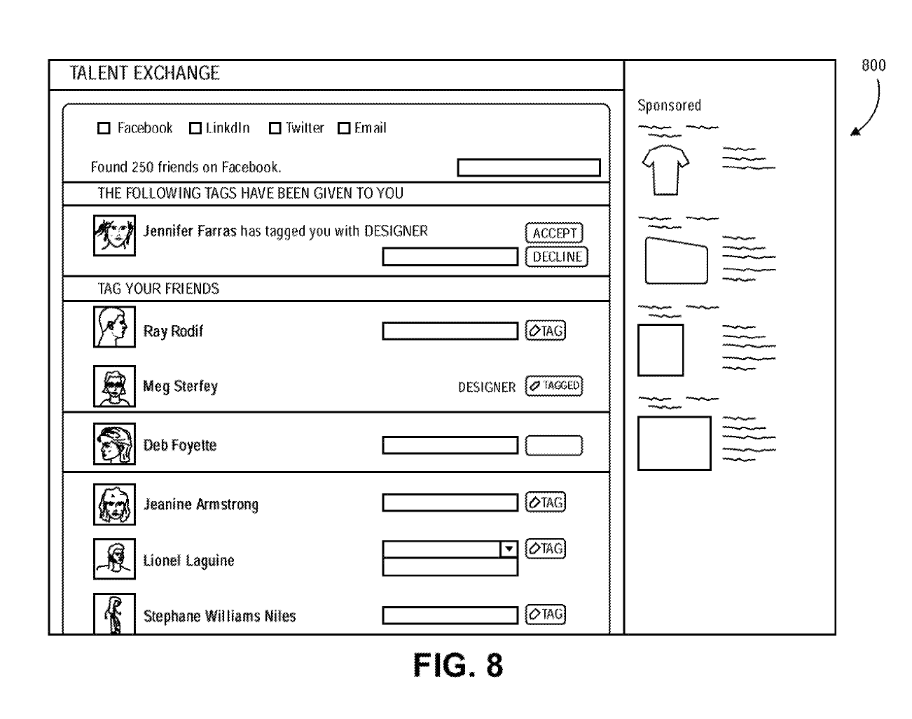

FIG. 8 is a screen shot 800 of steps 612, 614, 616 in the process flow chart of FIG. 6. The screen shot 800 depicts that Jennifer Farras has tagged the user with “designer” and the user has the option to accept this tag and/or to tagback Jennifer with a tag that the user may enter into the text field. In addition, the screen shot 800 depicts that Meg Herlihy has already been tagged with the tag “designer” and that the user is tagging Lionel Loquias with the tag “developer,” Additionally, the screen shot 800 depicts that Debi Boyette may be untagged by the user.

After a tag has been applied in any of FIGS. 2-8, that tag will then appear in a status update in the tagged person's social network. For example, if a user applies a tag to a Facebook friend, a status update will appear on that friend's Facebook wall stating that the user has tagged him in the talent exchange application. The friend may then click on the status update to see which tag has been applied to him,

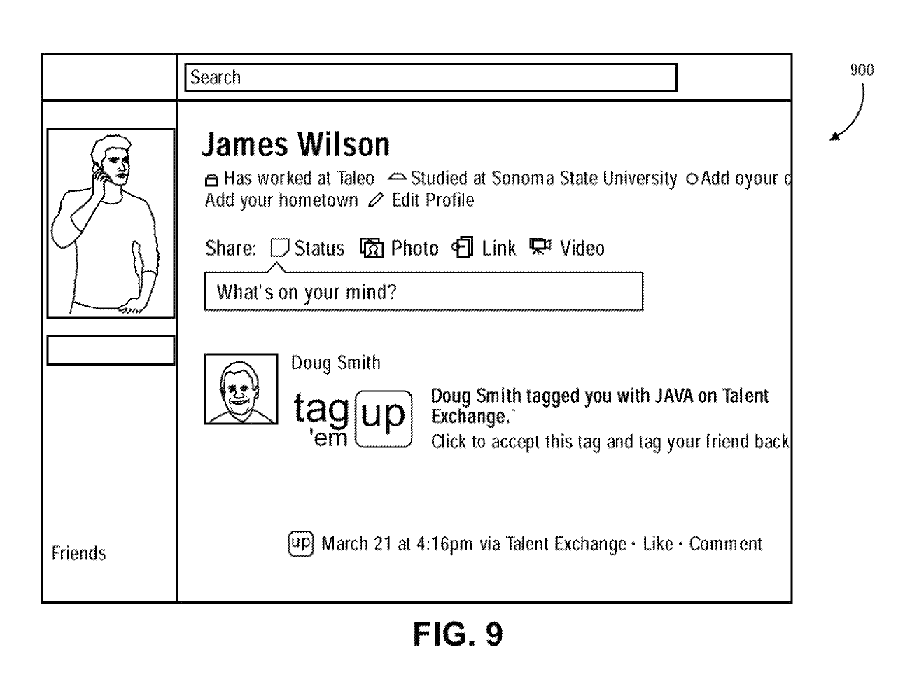

FIG. 9 is a screen shot 900 depicting a status update on user James Wilson's Facebook page, in accordance with one embodiment of the present disclosure. In the screen shot 900, the user's wall depicts a status update that states that Doug Smith has tagged James with the tag “Java” on the social tagging application. James may then click on the status update and accept the tag and/or tagback Doug, as shown in FIG. 8.

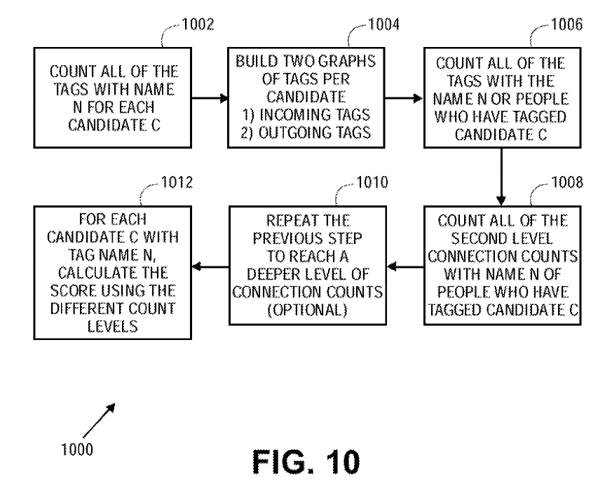

Referring now to FIG. 10, a process 1000 for scoring search results based on tags is shown, in accordance with one embodiment of the disclosure. As discussed previously, tags may be used by HR/recruiting managers to search for job candidates that may fit a particular need for their organization. Scoring these tags may improve the search results for the HR/recruiting managers, and if users know that their tags are scored, they may be incentivized to try to have each of their connections tag them with a specific tag. The scoring algorithms described below may be designed in such a way to get reasonable results in a reasonable amount of time.

The scoring process 1000 may be conducted on the employer side of the system architecture 100 in FIG. 1 and may be used by the HR/recruiting managers to search tags for potential job candidates. The process 1000 starts at step 1002 when logic on the talent exchange server 102 may call the tag database 112 and the profile database 114 and count all of the tags with name N for each candidate C. For example, if a HR/recruiting manager is searching for a web developer, he or she could search for the tag “developer” and the number of “developer” tags will be counted for each candidate with one or more of that particular tag. The pseudo code for step 1002 may comprise:

for (tag in new_tags) {
counts[tag.candidate][tag.name] += 1
}

At step 1004, the logic may build two graphs of tags for each candidate: one for incoming (received) tags and one for outgoing (given) tags. The pseudo code for step 1004 may comprise:

```
for (tag in new_tags) {
  incoming_tags[tag.candidate][tag.name].push(tag.tagger)
  outgoing_tags[tag.tagger][tag.name].push(tag.candidate)
}
```

At step 1006, the logic may count all of the tags with the name N of the people who tagged candidate C. The pseudo code for step 1006 may comprise:

```
for (candidate,tag_map in incoming_tags) {
  for (tag_name,tagger_list in incoming_tags) {
    for (tagger in tagger_list) {
      counts2[candidate] += counts[tagger][tag_name]
    }
  }
}
```

At step 1008, the logic may count all of the second level connection counts with the name N of the people who have tagged candidate C. The pseudo code for step 1008 may comprise:

```
for (candidate,tag_map in incoming_tags) {
  for (tag_name,tagger_list in incoming_tags) {
    for (tagger in tagger_list) {
      counts3[candidate] += counts2[tagger][tag_name]
    }
  }
}
```

At step 1010, the logic may repeat step 1008 one or more times to reach a deeper level of connection counts.

At step 1012, the logic may calculate a score S for each candidate C with tag N. The scores S may then be sorted and listed in order for the HR/recruiting managers to be able to use quickly and easily. The pseudo code for step 1012 may comprise:

```
score= counts[C][N]
for (i <= 2 to number_of_levels) {
  count_at_current_level = counts{i}[C][N];
  score+= log {2\hat{ }(i−1)}(count_at_current_level)//this is the log base
(2 to the power of i − 1) of the count at the current level
}
```

The results of the scoring algorithm may be used as an influence rating for each user. Users with higher scores for a specific tag such as “Java” may have a higher influence rating for that specific tag, whereas users with a higher scores for various tags may have a higher general influence rating. Within all of the users that may have high influence ratings for a specific tag, those users may be further sorted based on the data called from the tag database 112 and the profile database 114. For example, within all users with a high score for the tag “Java,” James Gosling, the founder of Java, will also have a very strong user profile that speaks to his experience and skills in the Java language. Accordingly, a “Java” tag from James Gosling would be scored higher, and thus be more valuable, than a “Java” tag from a user with a lot of Java tags who is not the founder of Java. These influence ratings may be used by HR/recruiting managers in order to give more weight to users with higher specific or general influence ratings.

Knowing that a scoring algorithm is in place, the social tagging application may utilize games/incentives to try to get users to increase their tagging score by increasing the number of given and received tags. Tagging leaderboards may be displayed on the social tagging application's user interface to try to leverage the idea of people trying to get the most tags in order to increase their scores. For example, if a developer wants to be the leader of the tag “Java,” he may have an incentive to try to get his friends to tag him with that word. Likewise, an HR/recruiting manager looking to hire a developer may follow the tag “Java” and will be able to see who the possible job candidates with the most tags are from the leaderboard.

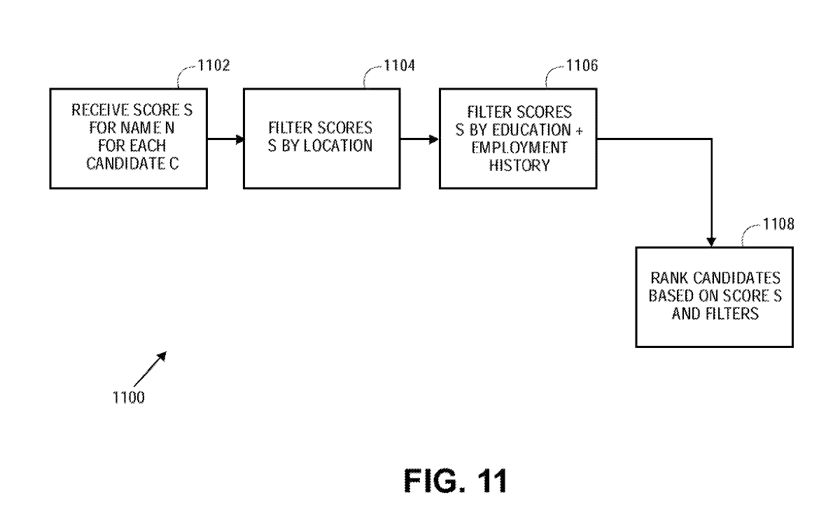

Referring now to FIG. 11, a process flow chart 1100 for HR/recruiting managers to find a job applicant for a specific job opening is shown, in accordance with one embodiment of the disclosure. Once the scoring process 1000 has been performed, at step 1102, logic on the talent exchange server 102 may receive scores S for each candidate C with tag N, tag N being the tag that the FIR/recruiting manager searches to fill a job opening.

At step 1104, the HR/recruiting manager may wish to filter the scores S based on the candidates' location. Each candidates' location may be stored either in the profile database 114 of the check-in database 116. The logic on the talent exchange server 102 may search the profile databases 114, 116 to filter the results. For example, if the HR/recruiting manager wishes to fill a job in Silicon Valley,the manager may filter all scores S for each candidate C with tag N to only those candidates C located in California.

At step 1106, the HR/recruiting manager may wish to further filter the scores S based on the candidates' employment history and/or educational history. Each candidates' employment and educational history may have been previously stored in the profile database 114. The logic on the talent exchange server 102 may search the profile database 114 to filter the results. Continuing with the same example, if the HR/recruiting manager wishes to fill the job only with electrical engineering managers who have at least three years work experience, the manager may filter all scores S for each candidate C with tag N for candidates C located in California to those that are also electrical engineers with at least three years work experience.

At step 1108, the job candidates may be ranked based on the scores S of for each candidate C with name N after being filtered down at steps 1104, 1106. This may provide the HR/recruiting manager with the shortest list of candidates that meet all search criteria so that the manager can be most efficient.

### Location-Based Networking

In addition to wanting to search for candidates based on tags, HR/recruiting managers may wish to network with job candidates while out-and-about based on the geographic locations of both the HR/recruiting manager and potential job candidates. This real-time networking may result in valuable connections and synergies that businesses may utilize in order to increase efficiencies and reduce costs. The location-based application may also help to facilitate impromptu meetings that might not otherwise occur by matching a person's talents and skills with potential opportunities in close proximity. The location-based application may also be used to enable talent networking by professionals by matching skills and experiences with potential opportunities. For example, a software development manager may be looking for a new developer that is proficient in a certain software language. If that developer is standing next to the software manager in line at a coffee shop or at a sporting event, that networking opportunity could be lost if the software manager and the developer do not know about each other and the potential opportunity.

The architecture of the location-based application may be centered around the talent exchange server 102 operating code comprising computer instructions stored on the computer-readable medium 107. The location-based application utilizes the check-in database 116 and the geo-position jobs database 118 in communication with the talent exchange server 102 of FIG. 1. The check-in database 116 may keep a record of where each user is located when they check-in with the location-based application. The geo-position jobs database 118 may keep a record of where job postings are located in relation to the location of users who have checked-in to the location-based application. Both the check-in database 116 and the geo-position jobs database 118 may utilize latitude and longitude and global positioning satellite (GPS) receivers in mobile devices in order to determine a user's geographic location for the location-based application. The system may further comprise the mobile proxy server 120 that may serve as a proxy into third party social networks such as Facebook or LinkedIn, incorporating the location of both users and jobs in the location-based application.

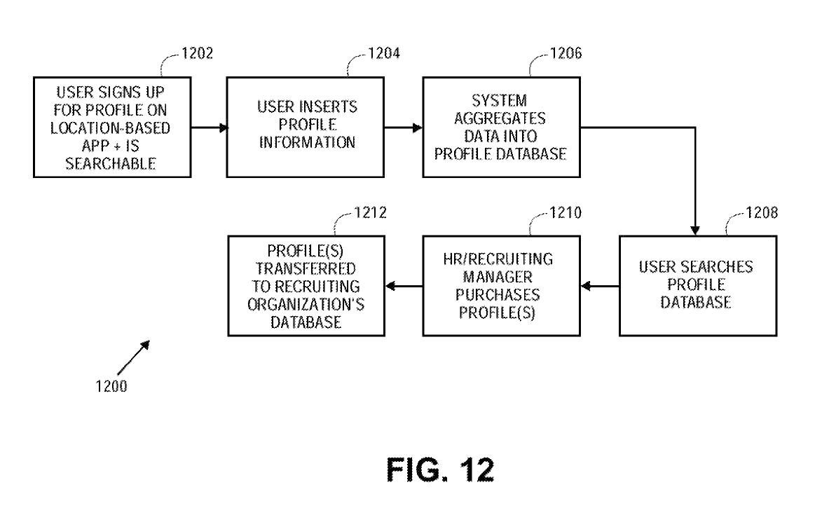

Referring now to FIG. 12, a process flow chart 1200 is shown for using a location-based application, in accordance with one embodiment of the present disclosure. At step 1202, a user may sign up for a profile on the location-based application. The profile may be the same profile as the profile discussed in FIG. 2, above, for social tagging or may be a separate profile running on a distinct application. The user may be required to enter and confirm a password that will later be used to log on to the application. Once a user signs up for a profile on the location-based application, he or she may be searchable by their application users. A user may be entered into the location-based application's search index by default unless the user specifically specifies otherwise.

At step 1204, the user may insert profile information into the application, which may be stored in the profile database 114. The profile information may include the user's name, address, education and employment history. The user's profile may also be tied to the tag database 112 and may contain a record of all tags from the social tagging application described in FIGS. 2-11. At step 1206, the system 100 of FIG. 1 may aggregate all data that the user inserts into the profile database 114 via the talent exchange server 102.

At step 1208, the user may search the profile database 114 via the talent exchange server 102. The user may search for potential job candidates or opportunities based on location, employment history, or educational history from the profile database 114 or tags from the tag database 112. If the user is a HR/recruiting manager wishing to view a specific profile, at step 1210, the HR/recruiting manager may be required to purchase the user's profile. At step 1212, the one or more purchased profiles may be transferred from the profile database 114 to the organization's database.

The user interface of the location-based application may include a series of tabs, giving the user access to major functions of the application. These tabs may include a “Me” tab, a “Near Me” tab, a “Connections” tab, and a “My Posts” tab, among others. Each of these functions are described in more details in the following figures.

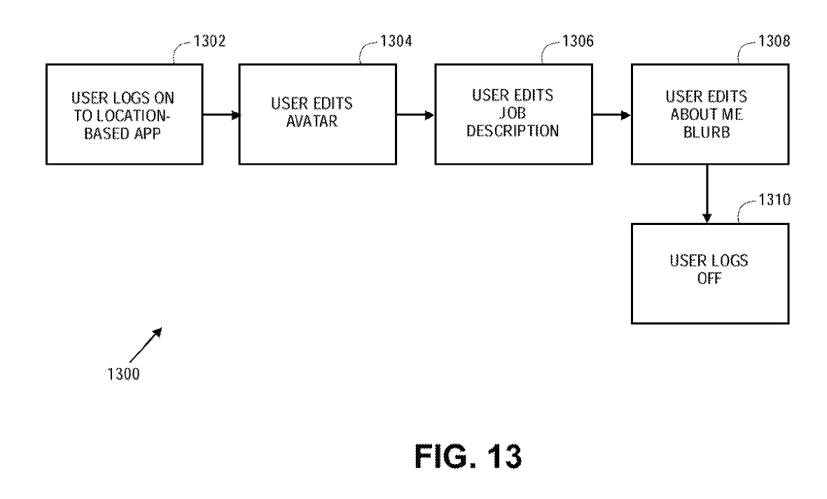

Referring now to FIG. 13, a process flow chart 1300 is shown for a user to edit their profile in the location-based application of FIG. 12, in accordance with one embodiment of the present disclosure. By selecting the “Me” tab on the user interface, the user may have the option of editing his or her personal profile information, which is stored in the profile database 114. At step 1302, the user may log on to the location-based application, which may include using the password created in FIG. 12. At step 1304, the user may edit his or her avatar. The user's avatar may be a small picture of either the user or any other graphical representation that the user wishes to portray to HR/recruiting managers. At step 1306, the user may edit his or her job description/title. This may be a generic title such as “designer” or may be a specific position that the user has at the user's current employer. At step 1308, the user may edit a short blurb about him or herself. At step 1310, the user may optionally decide to log off the location-based application or may decide to select another tab, as described in more detail later.

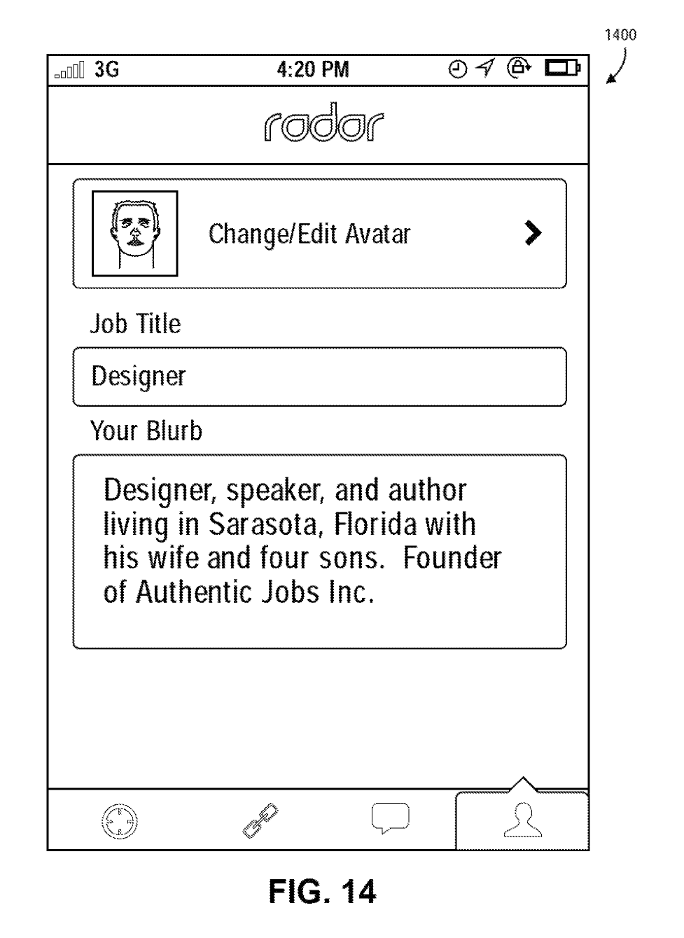

Referring now to FIG. 14, a screen shot 1400 depicting a user's profile in the location-based application of FIG. 13 is shown, in accordance with one embodiment of the present disclosure. The screen shot 1400 may depict what is visible when the user selects the “Me” tab in the user interface. In this embodiment, the user may select “Change/Edit Avatar” to change their avatar, as described at step 1304 above. The user's profile currently says that his job title is “Designer” and the short blurb helps further explain his current job, location, and family information.

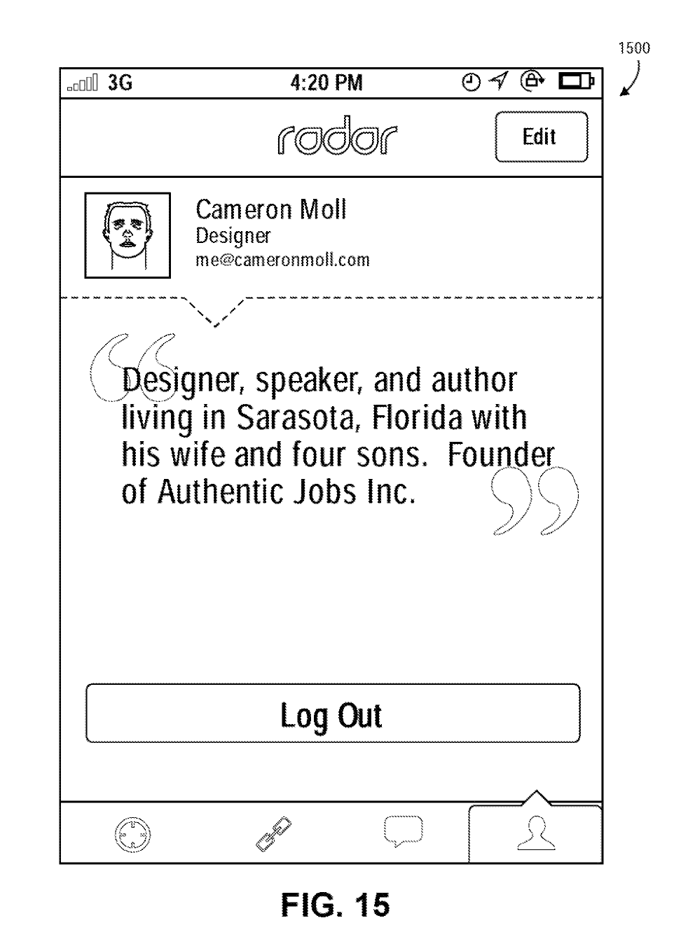

Referring now to FIG. 15, a screen shot 1500 depicting user Cameron Moll editing his profile in the location-based application of FIG. 13 is shown, in accordance with one embodiment of the present disclosure. In the screen shot 1500, the user has the option of editing his profile by selecting the “Edit” button in the upper-right hand corner. By selecting the “Edit” button, the user will have to option of editing his job title, contact info, and short blurb. In addition, the user has the option of logging out of the location-based application. The remaining screen shots in this application will be from Cameron's perspective when viewing the user interface on his mobile device.

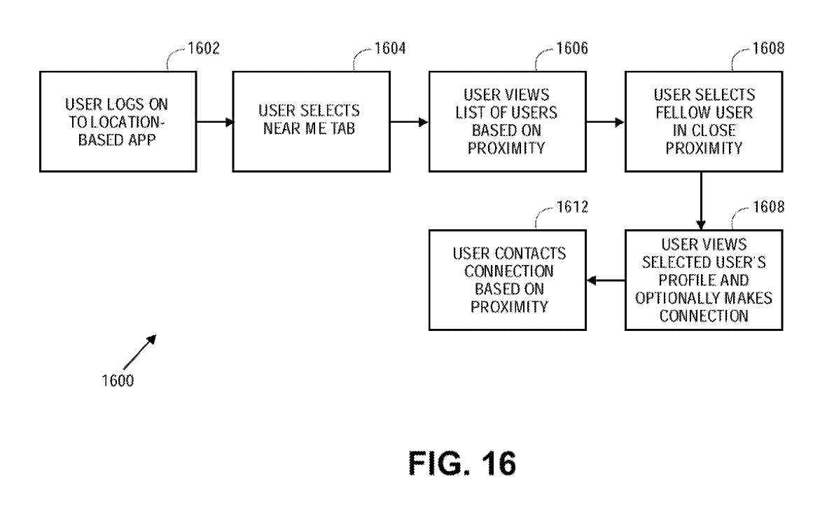

Referring now to FIG. 16, a process flow chart 1600 for a user to view other location-based application connections in close proximity to the user of FIG. 12 is shown, in accordance with one embodiment of the present disclosure. By selecting the “Near Me” tab on the user interface, the user may have the option of viewing his or her connections and the other location-based application users based on their geographic proximity. By viewing connections and/or other users in close proximity, professionals may be able to capitalize on networking opportunities that may not have otherwise presented themselves. As previously discussed, at step 1602, the user may log on to the location-based application, which may include using the password created in FIG. 12.

At step 1604, the user may select the “Near Me” tab on the user interface. At step 1606, the user may view a list of his or her connections based on their geographic proximity to the user. The geographic proximity of the connections may be calculated by longitude and latitude and the check-in database 116 and the geo-position jobs database 118. The list of connections in proximity to the user may be sorted by name, proximity, or connection status. At step 1608, the user may select a connection's profile to view from the list of those connections in close proximity, giving the user access to more detailed information about the connection from the profile database 114.

At step 1610, the user may view the selected connection's profile and may optionally connect with the connection. At step 1612, the user may contact the selected second user based on proximity. This may allow a potential job applicant to contact directly with a recruiter in close proximity after the potential job applicant determines that the recruiter works in a related industry and is looking to network or fill a specific job opening. In order to maintain some anonymity, the talent exchange server 102 may use push notifications that give users the option of responding to the notification. For example, if a user contacts a connection at step 1612, a push notification may be sent to the connection, giving the connection the option of responding to the user and establishing a networking connection.

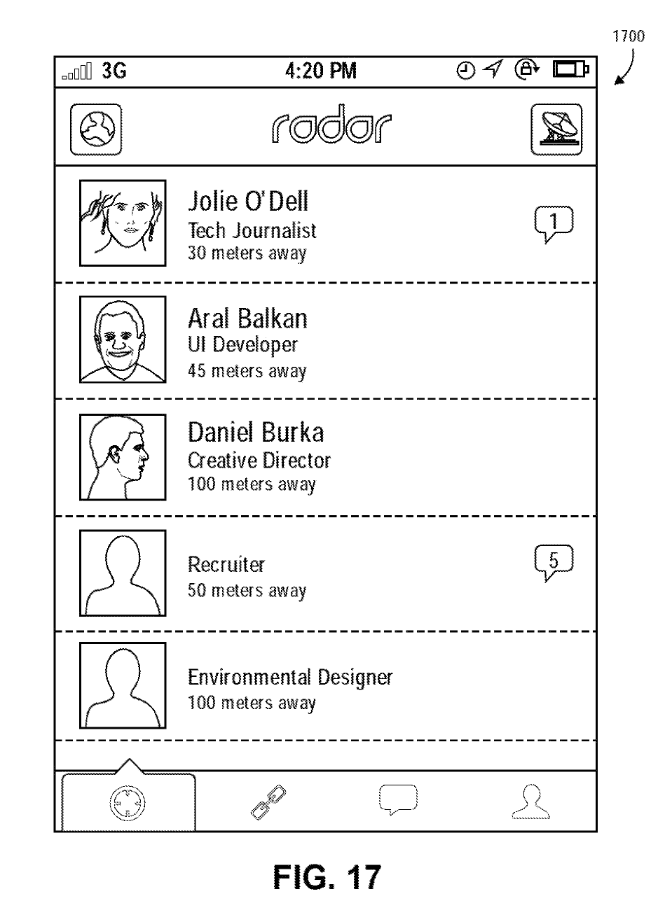

Referring now to FIG. 17, a screen shot 1700 depicting a list of a user's connections checked-in to the location-based application of FIG. 16 and their relative proximities to the user, in accordance with one embodiment of the present disclosure. The screen shot 1700 shows that three known connections—Jolie O'Dell, Aral Balkan, and Daniel Burka—are located within 100 meters of the user and that a recruiter and an environmental designer are also located within 100 meters. Also shown on the screen shot 1700 may be a globe button used for viewing the users on a map based on their latitude and longitude and a satellite button used for updating the user's location when he or she moves between locations. If the user selects any of his or her connection to view their profile in more detail, the talent exchange server 102 may recall that user's information from the profile database 114.

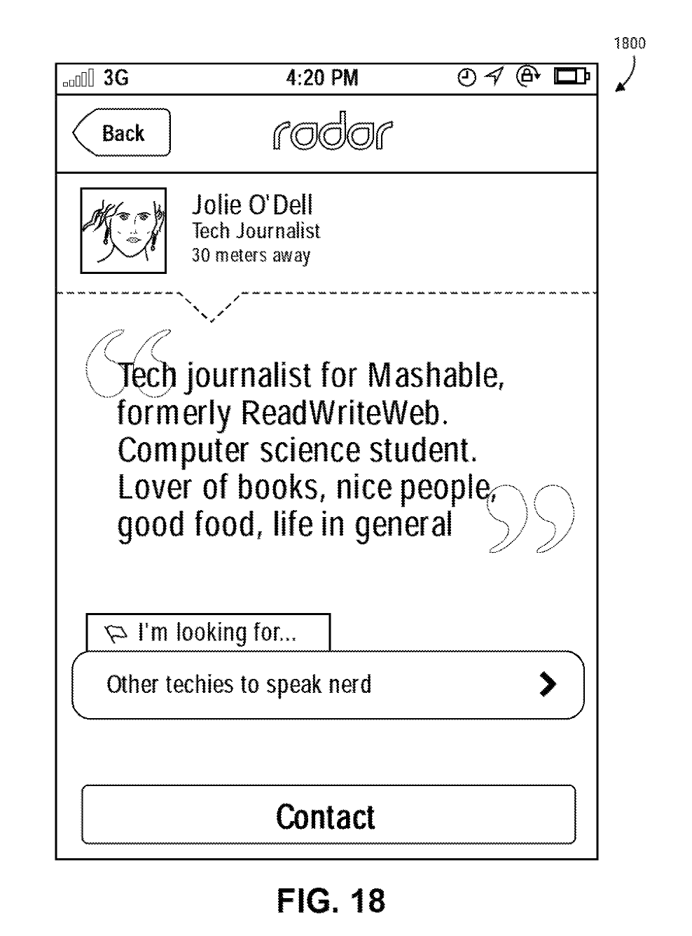

Referring now to FIG. 18, a screen shot 1800 depicting a detailed profile of a connection in close proximity to the user and an option to contact the connection of the location-based application of FIG. 17 is shown, in accordance with one embodiment of the present disclosure. The screen shot 1800 depicts that user Cameron has selected Jolie O'Dell's profile to view in more detail. Jolie's profile states that she is a Tech Journalist currently located 30 meters away and is looking for “other techies to speak nerd.” If the user wishes to connect with Jolie, he may select the “Contact” button, which would let Jolie know on her mobile device that Cameron wishes to network with her, helping to facilitate an in-person networking opportunity that might not otherwise have occurred.

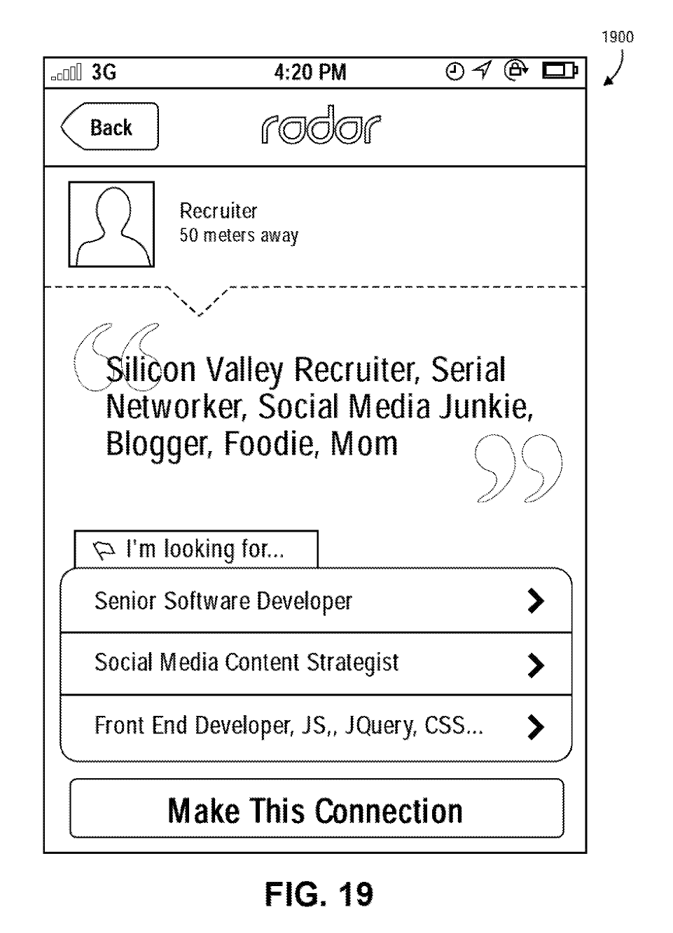

Referring now to FIG. 19, a screen shot 1900 depicting a detailed profile of a connection in close proximity to the user and an option to connect with the connection of the location-based application of FIG. 17 is shown, in accordance with one embodiment of the present disclosure. The screen shot 1900 depicts that Cameron has selected the recruiter's profile to view in more detail. The recruiter's profile states that she is a Silicon Valley recruiter currently located 50 meters away and is looking for a senior software developer, a social media contest strategist, and a front end developer. If Cameron wishes to talk to the recruiter about any of these opportunities, he may select “Make this connection,” which may ping the recruiter on her mobile device, alerting her that Cameron wishes to network with her, helping to facilitate an in-person networking opportunity.

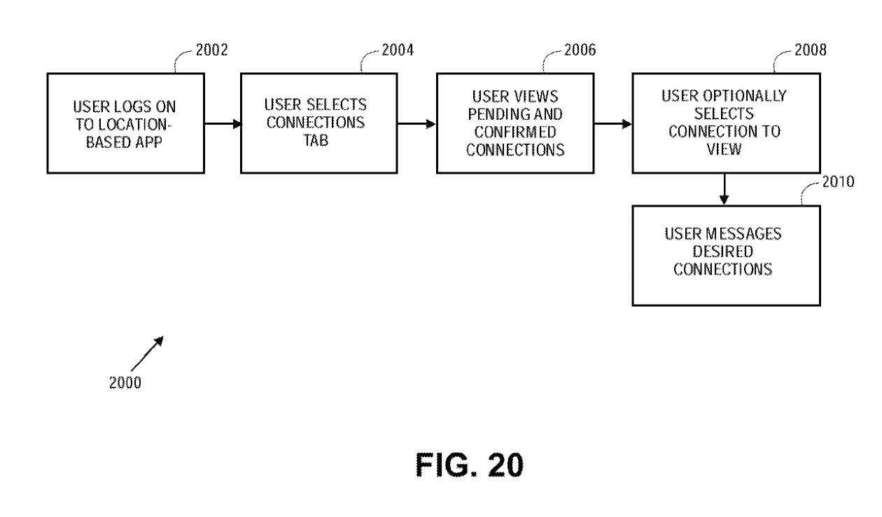

Referring now to FIG. 20, a process flow chart 2000 for a user to view his or her pending and confirmed connections of the location-based application of FIG. 12 is shown, in accordance with one embodiment of the present disclosure. By selecting the “Connections” tab on the user interface, the user may have the option of viewing his or her pending and confirmed connections. As previously discussed, at step 2002, the user may log on to the location-based application, which may include using the password created in FIG. 12.

At step 2004, the user may select the “Connections” tab on the user interface. At step 2006, the user may view his or her pending and confirmed connections, including each connection's name, job title, and date the connection was first pending or connected. At step 2008, the user may select one of his or her pending or confirmed connections to view in more detail, giving the user access to more detailed information about the connection from the profile database 114. At step 2010, the user may message one or more of his or her connections.

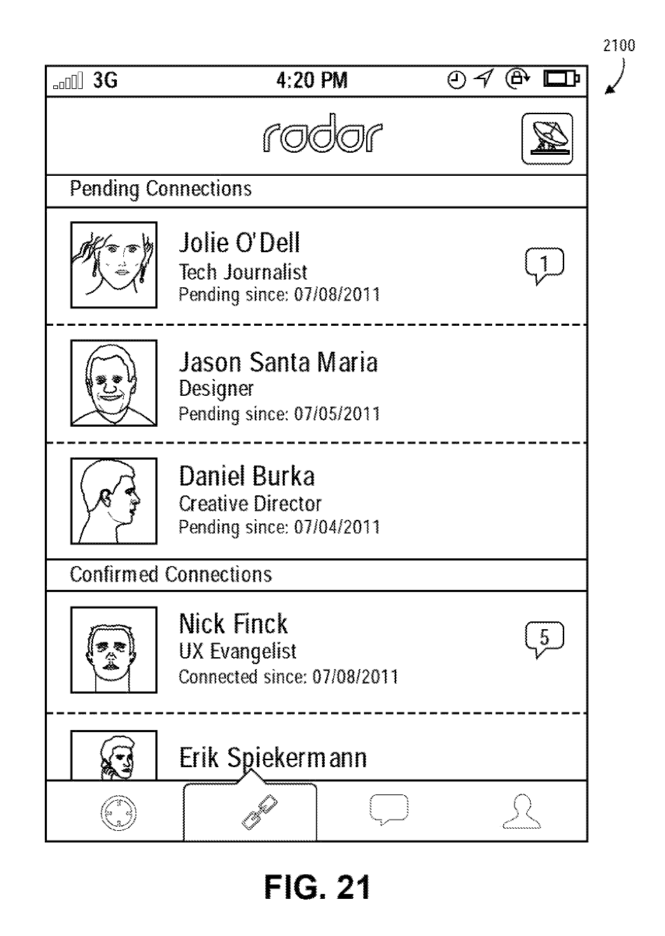

Referring now to FIG. 21, a screen shot 2100 depicting a user's pending and confirmed connections of the location-based application of FIG. 21 is shown, in accordance with one embodiment of the present disclosure. The screen shot 2100 depicts that user Cameron's pending connections include Jolie, Jason, and Daniel, while his confirmed connections include Nick and Erik. Each connection's name and job title are shown, along with the time the connection with Cameron began.

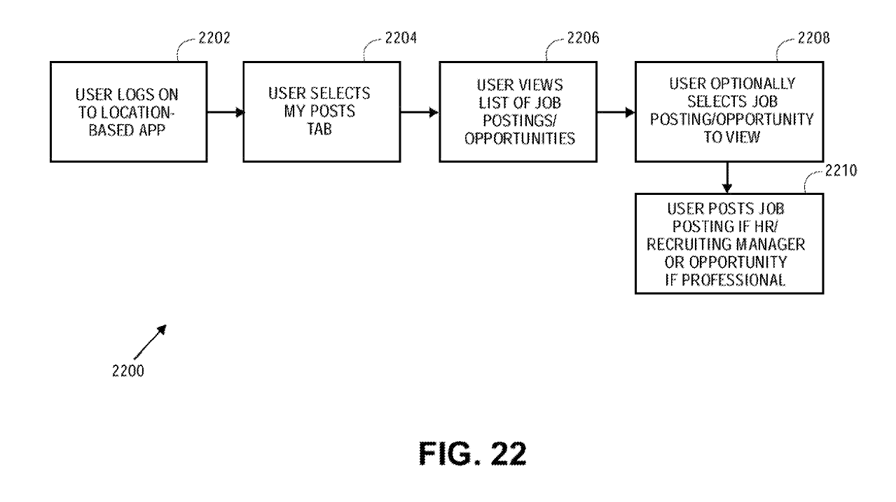

Referring now to FIG. 22, a process flow chart 1900 for a user to view and/or post job listings in the location-based application of FIG. 12 is shown, in accordance with one embodiment of the present disclosure. By selecting the “My Posts” tab on the user interface, the user may have the option of viewing and/or adding to the posts in his or her profile database 114. As previously discussed, at step 2202, the user may log on to the location-based application, which may include using the password created in FIG. 12.

At step 2204, the user may select the “My Posts” tab on the user interface. At step 2206, the user may view a list of postings that he or she created. If the user is an HR/recruiting manager, his posts may consist of job openings that he is trying to fill, while if the user is a potential job candidate, his posts may consist of jobs that he is looking to apply for. Posts may also be more broadly defined as opportunities including looking to connect with someone with a particular expertise. The HR/recruiting manager may then be able to search for nearby connections that are looking to apply for jobs and the job candidate may then be able to search for nearby connections that are looking to fill certain jobs. If the user is a professional looking to network, his posts may consist of unique talents, skills, and experiences that he has. The professional may then be able to search for potential opportunities within a certain geographic radius.

At step 2208, the user may select specific job postings and/or opportunities to view if he is looking to apply for a job or network while out-and-about. At step 2210, the user may add a new job posting if he is looking to fill a job opening for his organization.

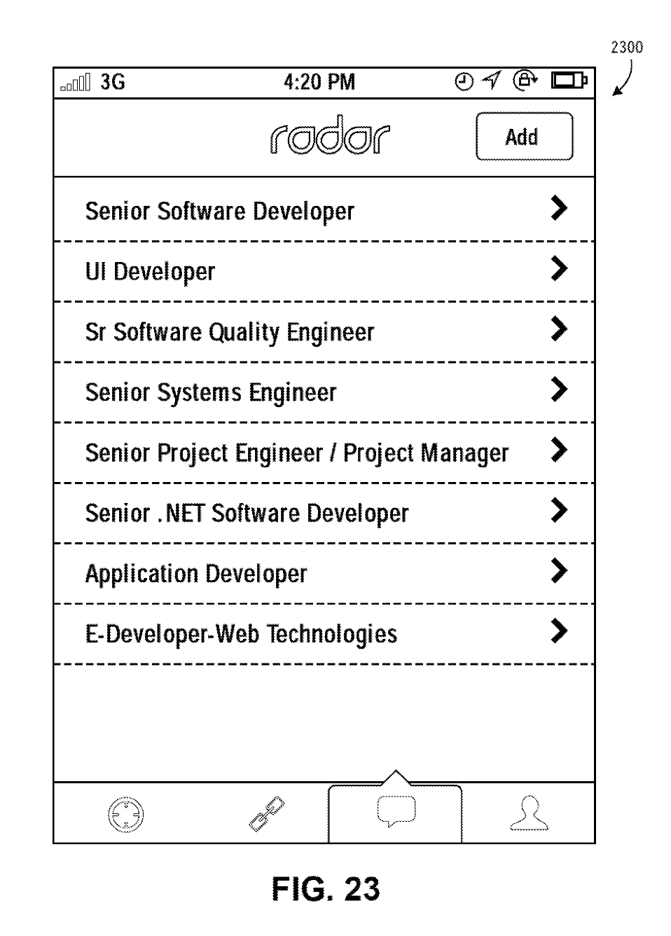

Referring now to FIG. 23, a screen shot 2300 depicting a series of job posts in the location-based application of FIG. 22 is shown, in accordance with one embodiment of the present disclosure. The screen shot 2300 depicts various job postings for software-related positions. The screen shot 2300 may be directed to view of a recruiter's user interface as the recruiter is able to add additional job postings by selecting the “Add” button in the upper right-hand corner. If a user selects a job post such as “Senior Software Developer,” the recruiter may be able to edit the job posting, as shown below.

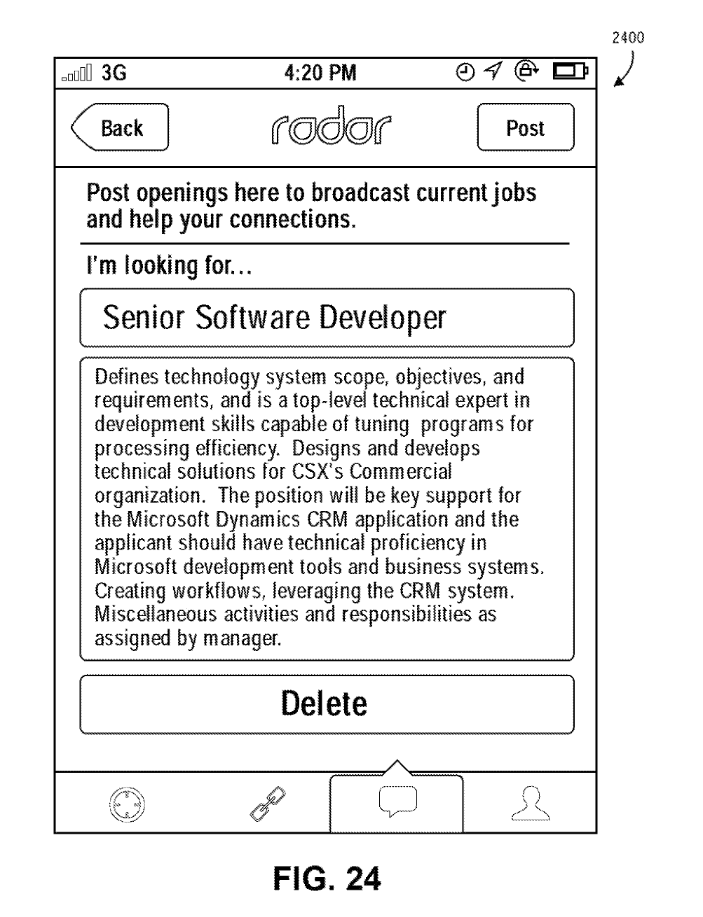

Referring now to FIG. 24, a screen shot 2400 depicting a detailed job post in the location-based application of FIG. 23 is shown, in accordance with one embodiment of the present disclosure. If the recruiter selects the “Senior Software Developer” job post in FIG. 23, the recruiter may be led to the screen shown by the screen shot 2400. The recruiter may have the ability to edit the job posting, delete the job posting, or post the job posting so that it is visible to other users.

Because job candidates are often on-the-go, managing their current job obligations at the same time as applying for a new job, job candidates may wish to apply for a job directly from their mobile device, especially after networking with a recruiter. Time is often of the essence for both job applicants and recruiters, and job applicants may want to immediately send their application to recruiters in order to capitalize on the recent networking meeting. If the job applicant is not able to send his or her resume to the recruiter immediately through their mobile device, the recruiter may fill the job opening with someone else. Likewise, recruiters may want to immediately check a job applicant's resume after networking introductions to see if the applicant's employment and educational credentials meet what the organization is looking for in a candidate.

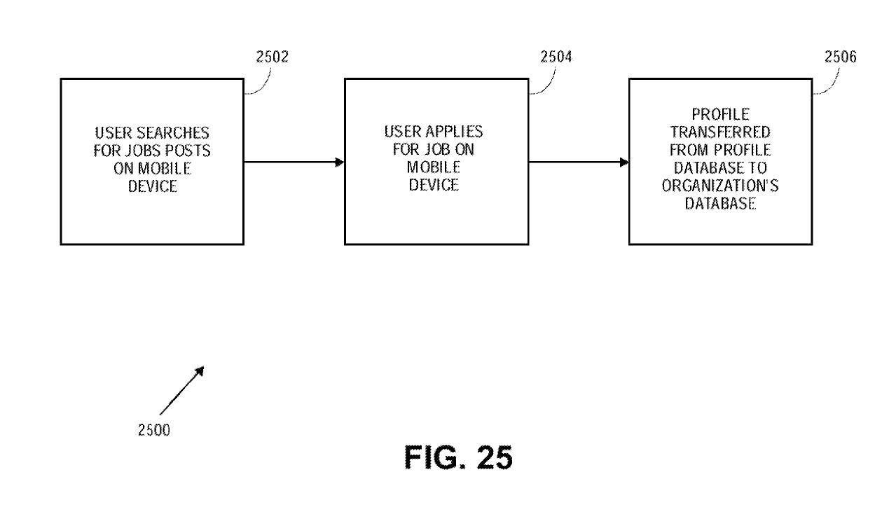

Referring now to FIG. 25, a process flow chart 2500 for a user to search for and apply for jobs on a mobile device is shown, in accordance with one embodiment of the present disclosure. At step 2502, the user may search for job posts and/or opportunities on the user interface of his or her mobile device. The job posts and/or opportunities may be searched through the geo-position jobs database 118 and the check-in database 116 via the talent exchange server 102. At step 2504, the user may apply for a job on their mobile device, populating information that the organization requires with information from the user's profile stored in the profile database 114. Optionally, the user may be able to apply for a job on their mobile device with a one-click application process. In the one-click application process, each of the fields that the organization may require from a job applicant, including name, title, address, telephone number, email address, birthday, industry, employment history, and education history, may already be stored in the profile database 114 and the talent exchange server 102 may pass that information to the UR/recruiting organization 108 automatically. If there are any additional fields unique to the specific organization, the user may have to enter that information from his or her mobile device directly. At step 2506, the user may transfer their profile and any additional information required from the profile database 114 to the organization's database in order to apply for the job.

Referring now to FIGS. 12-25, as discussed above, the connections, jobs, and job posts may also be shown on a map view. With a map view, a user may utilize a user interface to see which connections, jobs, and job posts may be located in close proximity at any given time. The map view may be easier for a user to use in order to see which connections, jobs, and job posts may be located at the same location at the same time, i.e., at the same coffee shop or bookstore. The map view may also allow a user to filter the map view for people and/or jobs. A user may choose to only show those connections that are both like him and near him. Similar connections may be determined based on both the tags and profiles. For example, a user may want to filter all of the connections shown on the map view to only those connections that contain a certain tag such as “Developer.” The location-based application may then search all connections that are located proximate to the user and only display those connections that contain the tag “developer” or list “developer” as their job title in their profile, allowing a user to view a “hot-spot” map to see if there is a large concentration of like-minded individuals in a specific area.

The map view may also allow a user to filter jobs on the map view so that only jobs that meet the user's profile/criteria are displayed. For example, a user may want to search only for job openings for software developer positions, so he may filter those jobs displayed to only those containing the word “developer.” Alternatively, the user may want to only display those job openings that match his profile and/or tags. For example, if a user is a software developer and has been tagged with “developer” by his professional associates, only jobs related to software development/engineering may be displayed on the map view.

An additional advantage of a map view may be that companies may pay to have advertisements appear on the user interface when a user is viewing the map view from a particular location. For example, if the mobile application user is located at 1200 Broadway and selects the map view, businesses located within certain radius of 1200 Broadway and who have paid for job advertisements may have their job advertisement appear on the map. The location-based application allows advertisers to only post relevant job postings when a potential job applicant is located in close proximity to the company with the job opening. Companies may also be able to target advertisements based on the user's tags or profile stored in the tag database 112 and profile database 114. For example, if a company has an opening for a product manager job in Jacksonville, Fla., they may choose to advertise to individuals that are located within a certain radius say 30 miles and that have the tag “product manager” or “product manager” in their profile. For the specific users who meet these requirements, advertisements and/or jobs may be dropped directly onto the map view.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

For example, as referred to herein, a machine or engine may be a virtual machine, computer, node, instance, host, or machine in a networked computing environment. Also as referred to herein, a networked computing environment is a collection of machines connected by communication channels that facilitate communications between machines and allow for machines to share resources. Network may also refer to a communication medium between processes on the same machine. Also as referred to herein, a server is a machine deployed to execute a program operating as a socket listener and may include software instances.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

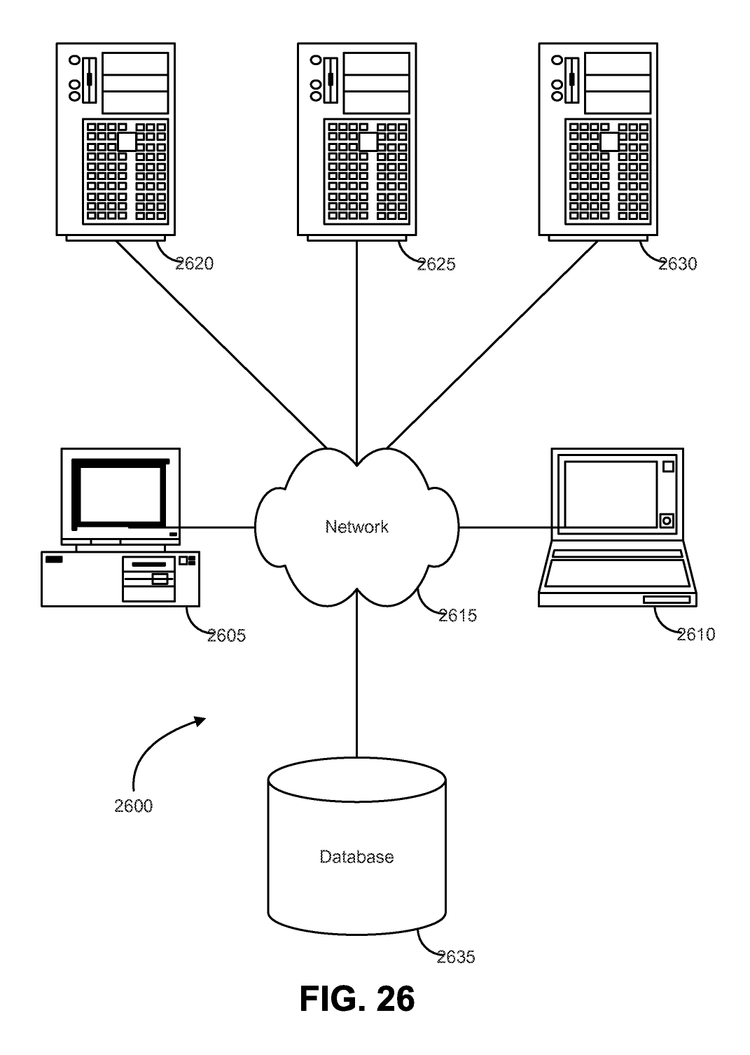

FIG. 26 is a block diagram illustrating components of an exemplary operating environment in which various embodiments of the present invention may be implemented. The system 2600 can include one or more user computers 2605, 2610, which may be used to operate a client, whether a dedicate application, web browser, etc. The user computers 2605, 2610 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 2605, 2610 may also have any of a variety of applications, including one or more development systems, database client and/or server applications, and web browser applications. Alternatively, the user computers 2605, 2610 may be any other electronic device, such as a thin-client computer, Internet-enabled mobile telephone, and/or personal digital assistant, capable of communicating via a network (e.g., the network 2615 described below) and/or displaying and navigating web pages or other types of electronic documents. Although the exemplary system 2600 is shown with two user computers, any number of user computers may be supported.

In some embodiments, the system 2600 may also include a network 2615. The network may can be any type of network familiar to those skilled in the art that can support data communications using any of a variety of commercially-available protocols, including without limitation TCP/IP, SNA, IPX, AppleTalk, and the like. Merely by way of example, the network 2615 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 2620, 2625, 2630 which can be general purpose computers and/or specialized server computers (including, merely by way of example, PC servers, UNIX servers, mid-range servers, mainframe computers rack-mounted servers, etc.). One or more of the servers (e.g., 2630) may be dedicated to running applications, such as a business application, a web server, application server, etc. Such servers may be used to process requests from user computers 2605, 2610. The applications can also include any number of applications for controlling access to resources of the servers 2620, 2625, 2630.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 2605, 2610. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 2605, 2610.

In some embodiments, an application server may create web pages dynamically for displaying on an end-user (client) system. The web pages created by the web application server may be forwarded to a user computer 2605 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 2600 may also include one or more databases 2635. The database(s) 2635 may reside in a variety of locations. By way of example, a database 2635 may reside on a storage medium local to (and/or resident in) one or more of the computers 2605, 2610, 2615, 2625, 2630. Alternatively, it may be remote from any or all of the computers 2605, 2610, 2615, 2625, 2630, and/or in communication (e.g., via the network 2620) with one or more of these. In a particular set of embodiments, the database 2635 may reside in a storage-area network (“SAN”) familiar to those skilled in the art. Similarly, any necessary files for performing the functions attributed to the computers 2605, 2610, 2615, 2625, 2630 may be stored locally on the respective computer and/or remotely, as appropriate. In one set of embodiments, the database 2635 may be a relational database, such as Oracle 10 g, that is adapted to store, update, and retrieve data in response to SQL-formatted commands.

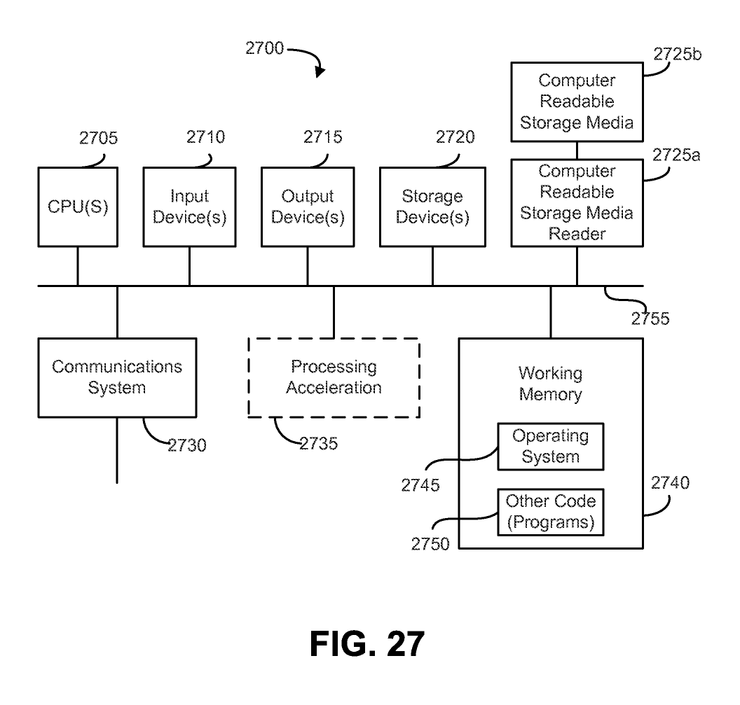

FIG. 27 illustrates an exemplary computer system 2700, in which various embodiments of the present invention may be implemented. The system 2700 may be used to implement any of the computer systems described above. The computer system 2700 is shown comprising hardware elements that may be electrically coupled via a bus 2755. The hardware elements may include one or more central processing units (CPUs) 2705, one or more input devices 2710 (e.g., a mouse, a keyboard, etc.), and one or more output devices 2715 (e.g., a display device, a printer, etc.). The computer system 2700 may also include one or more storage device 2720. By way of example, storage device(s) 2720 may be disk drives, optical storage devices, solid-state storage device such as a random access memory (“RAM”) and/or a read-only memory (“ROM”), which can be programmable, flash-updateable and/or the like.

The computer system 2700 may additionally include a computer-readable storage media reader 2725a, a communications system 2730 (e.g., a modem, a network card (wireless or wired), an infra-red communication device, etc.), and working memory 2740, which may include RAM and ROM devices as described above. In some embodiments, the computer system 2700 may also include a processing acceleration unit 2735, which can include a DSP, a special-purpose processor and/or the like.

The computer-readable storage media reader 2725a can further be connected to a computer-readable storage medium 2725b, together (and, optionally, in combination with storage device(s) 2720) comprehensively representing remote, local, fixed, and/or removable storage devices plus storage media for temporarily and/or more permanently containing computer-readable information. The communications system 2730 may permit data to be exchanged with the network 2720 and/or any other computer described above with respect to the system 2700.

The computer system 2700 may also comprise software elements, shown as being currently located within a working memory 2740, including an operating system 2745 and/or other code 2750, such as an application program (which may be a client application, web browser, mid-tier application, RDBMS, etc.). It should be appreciated that alternate embodiments of a computer system 2700 may have numerous variations from that described above. For example, customized hardware might also be used and/or particular elements might be implemented in hardware, software (including portable software, such as applets), or both. Further, connection to other computing devices such as network input/output devices may be employed. Software of computer system 2700 may include code 2750 for implementing embodiments of the present invention as described herein.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of managing a talent network, the method comprising:
registering each of a plurality of users of the talent network, wherein registering each user includes generating a profile for each user and defining professional information in the profile for each user, the professional information defined based on at least one of information imported from one or more social network profiles of the user or information provided by the user;
searching a selected social network for connections associated with each of the plurality of registered users in the selected social network; and
applying a tag to each connection identified by said searching, each tag comprising a unique endorsement of the connection by the registered user associated with that connection.

2. The method of claim 1, further comprising using the talent network to identify job candidates for an open position, wherein using the talent network to identify job candidates for the open position comprises:
searching the tags applied to each connection for information matching a criteria related to the open position to identify the job candidates from the connections;
counting a number of connections at each of a plurality of levels for each of the job candidates based on the tags applied to connection; and
scoring each job candidate based on the number of connections at each of the plurality of levels.

3. The method of claim 2, further comprising:
reading the score for each of the job candidates;
filtering the job candidates based on a location of the job candidate and a location criteria of the open position;
filtering the job candidates based on an education and employment history of the candidate and education and employment criteria of the open position; and
ranking the job candidates based on the score for each of the job candidates and said filtering.

4. The method of claim 1, wherein registering the plurality of users comprises registering one or more of the plurality of users for a location-based service of the talent network.

5. The method of claim 4, further comprising:
providing to a first registered user of the location-based service a list of other registered users based on proximity;
receiving from the first user a selection of one of the other registered users of the list of other registered users;
providing to the first user the user profile of the selected other registered user; and
in response to an instruction from the first registered user, adding a connection from the first user to the selected other registered user in the talent network.

6. The method of claim 4, further comprising:
providing to a registered user of the location-based service information about a set of open positions or user profile information for users in search of open positions based on location information of the location-based service;
receiving input from the registered user for the information about the set of open positions or user profile information for users in search of open positions; and
updating the information about the set of open positions or user profile information for users in search of open positions based on the input from the registered user.

7. The method of claim 2, further comprising:
searching the one or more open positions based on the user profile for one of the registered users;
providing to the user an indication of one or more open positions based on said searching;
receiving from the user a selection of one of the open positions; and
updating application information related to the selected open position using information from the user profile of the user.

8. A system comprising:
a processor; and
a memory coupled with and readable by the processor and having stored therein a sequence of instructions which, when executed by the processor, cause the processor to manage a talent network by registering each of a plurality of users of the talent network, wherein registering each user includes generating a profile for each user and defining professional information in the profile for each user, the professional information defined based on at least one of information imported from one or more social network profiles of the user or information provided by the user, searching a selected social network for connections associated with each of the plurality of registered users in the selected social network, and applying a tag to each connection identified by said searching, each tag comprising a unique endorsement of the connection by the registered user associated with that connection.

9. The system of claim 8, further comprising using the talent network to identify job candidates for an open position, wherein using the talent network to identify job candidates for the open position comprises:
searching the tags applied to each connection for information matching a criteria related to the open position to identify the job candidates from the connections;
counting a number of connections at each of a plurality of levels for each of the job candidates based on the tags applied to connection; and
scoring each job candidate based on the number of connections at each of the plurality of levels.

10. The system of claim 9, further comprising:
reading the score for each of the job candidates;
filtering the job candidates based on a location of the job candidate and a location criteria of the open position;
filtering the job candidates based on an education and employment history of the candidate and education and employment criteria of the open position; and
ranking the job candidates based on the score for each of the job candidates and said filtering.

11. The system of claim 8, wherein registering the plurality of users comprises registering one or more of the plurality of users for a location-based service of the talent network.

12. The system of claim 11, further comprising:
providing to a first registered user of the location-based service a list of other registered users based on proximity;
receiving from the first user a selection of one of the other registered users of the list of other registered users;
providing to the first user the user profile of the selected other registered user; and
in response to an instruction from the first registered user, adding a connection from the first user to the selected other registered user in the talent network.

13. The system of claim 11, further comprising:
providing to a registered user of the location-based service information about a set of open positions or user profile information for users in search of open positions based on location information of the location-based service;
receiving input from the registered user for the information about the set of open positions or user profile information for users in search of open positions; and
updating the information about the set of open positions or user profile information for users in search of open positions based on the input from the registered user.

14. The system of claim 9, further comprising:
searching the one or more open positions based on the user profile for one of the registered users;
providing to the user an indication of one or more open positions based on said searching;
receiving from the user a selection of one of the open positions; and
updating application information related to the selected open position using information from the user profile of the user.

15. A computer-readable memory device having stored therein a sequence of instructions which, when executed by a processor, cause the processor to manage a talent network by:
registering each of a plurality of users of the talent network, wherein registering each user includes generating a profile for each user and defining professional information in the profile for each user, the professional information defined based on at least one of information imported from one or more social network profiles of the user or information provided by the user;
searching a selected social network for connections associated with each of the plurality of registered users in the selected social network; and
applying a tag to each connection identified by said searching, each tag comprising a unique endorsement of the connection by the registered user associated with that connection.

16. The computer-readable memory device of claim 15, further comprising using the talent network to identify job candidates for an open position, wherein using the talent network to identify job candidates for the open position comprises:
searching the tags applied to each connection for information matching a criteria related to the open position to identify the job candidates from the connections;
counting a number of connections at each of a plurality of levels for each of the job candidates based on the tags applied to connection; and
scoring each job candidate based on the number of connections at each of the plurality of levels.

17. The computer-readable memory device of claim 16, further comprising:
reading the score for each of the job candidates;
filtering the job candidates based on a location of the job candidate and a location criteria of the open position;
filtering the job candidates based on an education and employment history of the candidate and education and employment criteria of the open position; and
ranking the job candidates based on the score for each of the job candidates and said filtering.

18. The computer-readable memory device of claim 15, wherein registering the plurality of users comprises registering one or more of the plurality of users for a location-based service of the talent network.

19. The computer-readable memory device of claim 18, further comprising:
providing to a first registered user of the location-based service a list of other registered users based on proximity;
receiving from the first user a selection of one of the other registered users of the list of other registered users;
providing to the first user the user profile of the selected other registered user; and
in response to an instruction from the first registered user, adding a connection from the first user to the selected other registered user in the talent network.

20. The computer-readable memory device of claim 18, further comprising:
providing to a registered user of the location-based service information about a set of open positions or user profile information for users in search of open positions based on location information of the location-based service;
receiving input from the registered user for the information about the set of open positions or user profile information for users in search of open positions; and
updating the information about the set of open positions or user profile information for users in search of open positions based on the input from the registered user.
